(19) United States
(12) Patent Application Publication
(10) Pub. No.: US 2002/0069162 A1
(43) Pub. Date: Jun. 6, 2002

(54) Method for payment, user equipment, server, payment system and computer program product

(76) Inventors: Cornelius Boylan, Geilenkirchen (DE); Guido Zavagli, Tokyo (JP)

Correspondence Address: Spencer C. Patterson, Esq., Jenkens and Gilchrist, P.C., 3200 Fountain Place, 1445 Ross Ave., Dallas, TX, 75202, US

(21) Appl. No.: 09/999,364

(22) Filed: Nov. 14, 2001

(30) Foreign Application Priority Data
Nov. 15, 2000 (EP) 00124901.0

(51) Int. Cl. G06F 17/60

(52) U.S. Cl. 705/39; 705/40

(57) ABSTRACT

A method of automatically paying an amount to a merchant account includes a merchant identifier and a transaction amount acquired from user equipment. The transaction amount is verified and the transaction amount is transferred to the merchant account. At least one parameter of the payment depends on the position of the user equipment. The user equipment sends a purchase request message to a first server. The purchase request message includes information about the location of the user equipment. The first server sends an authorization request message that contains the location information to an authorization server. The authorization server decides about an authorization of the payment by evaluating the location information and the authorization center decides about the authorization of the payment by evaluating the location information and the authorization center sends an authorization response message to the first server depending on the evaluation of the location information.

### BACKGROUND OF THE INVENTION

1. Technical Field of the Invention

The invention relates to the area of electronic payment. A number of secure transaction processing schemes has been proposed to allow payment activities. Electronic payments cover different aspects as for example payment activities over the Internet or according to Internet related protocols or payments with smart cards at points of sale. Wireless user equipment (UE) in particular are seen as a major enabler of electronic commerce.

2. History of Related Art

International patent application WO 98/47116 describes a method of facilitating automated payment from a customer account of a customer financial institution to a merchant account of a merchant financial institution in which a determination is made whether a mobile station of the customer and a merchant terminal are within a predetermined geographical proximity. A transfer of the transaction amount from the customer account to the merchant account is precluded unless the customer mobile station and the merchant terminal are within the predetermined geographical proximity.

Though the method described in WO 98/47116 enables high security levels of payment, it would be desirable to achieve a more flexible solution that also includes a high degree of security.

### SUMMARY OF THE INVENTION

It is an object of embodiments of the invention to create a method that enables a secure payment and that effectively and efficiently supplies users of user equipment (UE) with varying payment abilities.

Embodiments of the invention make use of the idea that the user equipment (UE) sends a purchase request message, wherein the purchase request message includes information about the location of the user equipment (UE), to a first server (S1) and that the first server (S1) generates an authorization request message (ARM). The authorization request message (ARM) includes information about the location and about the payee and/or a reason of payment. The first server (S1) sends the authorization request message (ARM) to an authorization server (AS).

The server is a logical element that preferably acts as a service node of a telecommunication network.

According to embodiments of the invention, an automatic payment to a merchant account is performed on the basis of a purchase request message from a user equipment (UE) to a first server (S1), which is most preferably a logical node operated by or on behalf of the merchant. The purchase request message includes location information. Afterwards, the first server (S1) sends an authorization request message (ARM), which also contains location information of the user equipment (UE). Furthermore, the authorization request message (ARM) contains at least one payment condition parameter. The payment condition parameter can be chosen flexibly. For example, the payment condition parameter contains information about the payer, the payee, or the amount of payment.

In advantageous embodiments of the invention, the authorization request message (ARM) also contains information about at least one payment condition parameter.

A preferred embodiment implies a handling of payment transactions according to two different parameters. One of these parameters is based on location information of the user equipment (UE), which is accessed by the user. The other parameter that influences the handling of the transaction is based upon information about circumstances of the transaction. This embodiment allows an adaptation of transaction procedures to different legal systems. For example, it is possible to prevent actions that are undesired in certain legal entities, such as, for example, concerning illegal gambling. A recent court decision in the United States ruled that a credit card company was liable for the fact that one of their customers made an illegal gambling transaction via the Internet, wherein the gambling server was located in a foreign country.

In a preferred embodiment of the invention, the authorization center (AC) decides about the authorization of the payment by evaluating the location information and the payment condition parameter.

The evaluation of the location information and the payment condition parameter enable the payment provider to authorize a payment transaction by regarding the current location information of the user. For example, a payment provider might use different risk management policies depending on the current location of the customer. Embodiments of the invention allow implementation of these risk management policies into automated payment systems.

In an advantageous embodiment of the invention, the authorization server (AS) decides about the authorization by evaluating the country in which the user equipment (UE) is located.

It is possible to reduce the amount of accessible money according to the risk status of countries. It is even possible to prohibit money transfers in high risk countries.

In a preferred embodiment of the invention, a second server decides about the authorization by evaluating a risk status of the region in which the user equipment (UE) is located. Through this embodiment it is, for example, possible to reduce the accessible amount in disadvantaged areas.

In an advantageous embodiment of the invention, the payment condition parameter contains information about the payee.

In a preferred embodiment of the invention, the payment condition parameter contains information about the payer.

In an advantageous embodiment of the invention, the payment condition parameter contains information about a reason of the payment.

In a preferred embodiment of the invention, the location information is obtained from a position of a base station (BS) of a communication system, wherein the base station (BS) is capable of sending and/or receiving signals from the user equipment (UE).

In an advantageous embodiment of the invention, the relative position between the user equipment (UE) and a base station (BS) of a multiple access communication system is evaluated.

In a preferred embodiment of the invention, the user equipment (UE) evaluates its position relative to signal sending devices of a positioning system.

In an advantageous implementation of the embodiment, the positioning system is the Global Positioning System.

Especially for the issuers of credit cards it is advantageous that embodiments of the invention enable them to control credit card transactions better. Furthermore, it is advantageous that the transactions are subject to varying regional and national regulations.

Embodiments of the invention allow an implementation of the regional and national regulations to the decision about the payment.

Any of these measures reduces the risk of bad debt as well as the risk of the card issuing organization of being held responsible for illegal actions performed by the users of credit cards issued by the credit card organization.

A combination of preferred embodiments of the invention, especially usage of different payment condition parameters reflecting different aspects of the payment, further decreases the risks for the credit card issuers.

The risks for the credit card issuers can be even further reduced, if the purchase request message is at least partly encrypted. It is especially useful, if at least the location information is encrypted. This prevents a fraudulent merchant from manipulating the first server (S1) in a way that location information can be changed fraudulently. This high security implementation is especially helpful to avoid a usage of the payment system by illegal organizations.

In an advantageous embodiment of the invention, the user equipment (UE) includes means for handling location information and the user equipment (UE) includes means for sending a purchase request message and means for adding location information to the purchase request message.

In a preferred embodiment of the invention, the user equipment (UE) obtains the location information by taking the location of at least one base station (BS).

In an advantageous embodiment of the invention, the user equipment (UE) obtains the location information by evaluating its relative position to at least one base station (BS).

In a preferred embodiment of the invention, the user equipment (UE) obtains its coordinates relative to signal sending devices of a positioning system.

In an advantageous embodiment of the invention, the first server (S1) is capable of receiving a purchase request message from a user equipment (UE).

The user equipment (UE) is capable of sending an authorization request message (ARM) that contains location information about the user equipment (UE).

In a preferred embodiment of the invention, the authorization request message (ARM) contains location information of the user equipment (UE) and the authorization server (AS) decides about the authorization of the payment by evaluating the location information.

In an advantageous embodiment of the invention, the server is capable of receiving a purchase request message from a user equipment (UE).

The server is preferably capable of sending an authorization request message (ARM) that contains location information about the user equipment (UE). The location information is advantageously derived from the purchase request message.

A further object of the invention is a payment system with a first server (S1), a gateway server, and an authorization server (AS). The first server (S1) is capable of receiving a purchase request message of a user equipment (UE) and of sending an authorization request message (ARM). The authorization center (AC) decides about an authorization of a payment.

The payment system is preferably capable of deriving location information from the purchase request message.

The first server (S1) sends an authorization request message (ARM) to the authorization server (AS) and the authorization server (AS) decides about the authorization of the payment by evaluating the location information.

In an advantageous embodiment of the invention, an article of manufacture includes a computer program loadable in user equipment (UE) and the computer program controls generation and/or sending of a purchase request message from the user equipment (UE). The computer program adds location information to the purchase request message.

In a preferred embodiment of the invention, the article of manufacture encrypts the location information.

In an advantageous embodiment of the invention, an article of manufacture includes a program loadable in a first server (S1) and the computer program is capable of taking location information from a purchase request message received by the first server (S1) and the computer program product is capable of adding the location information to an authorization request message (ARM) which is sent from the first server (S1) to an authorization server (AS).

An article of manufacture includes at least one computer readable medium and processor instructions contained on the at least one computer readable medium. The processor instructions are configured to be readable from the at least one computer readable medium by at least one processor and thereby cause the at least one processor to operate as to control at least one of generation and sending of a purchase request message from the user equipment and add location information to the purchase request message.

An article of manufacture includes at least one computer readable medium and processor instructions contained on the at least one computer readable medium. The processor instructions are configured to be readable from the at least one computer readable medium by at least one processor and thereby cause the at least one processor to operate as to take location information from a purchase request message received by a first server and add the location information to an authorization request message sent from the first server to an authorization server.

An article of manufacture includes at least one computer readable medium and processor instructions contained on the at least one computer readable medium. The processor instructions are configured to be readable from the at least one computer readable medium by at least one processor and thereby cause the at least one processor to operate as to decide about an authorization of a payment by evaluating location information included in an authorization request message.

In a preferred embodiment of the invention, an article of manufacture includes a computer program that is loadable in an authorization server (AS). The computer program is capable of deciding about an authorization of a payment by evaluating location information contained in the authorization request message (ARM).

### BRIEF DESCRIPTION OF THE DRAWINGS

In the following, preferred embodiments and advantages of the invention will be further described by means of examples and by means of the Figures:

FIG. 1 shows a schematic overview of a communication system;

FIG. 2 shows sequences of an advantageous implementation of the invention; and

FIG. 3 shows sequences for generating a digital envelope for an encrypted transmission of the location information.

### DETAILED DESCRIPTION OF EXEMPLARY EMBODIMENTS OF THE INVENTION

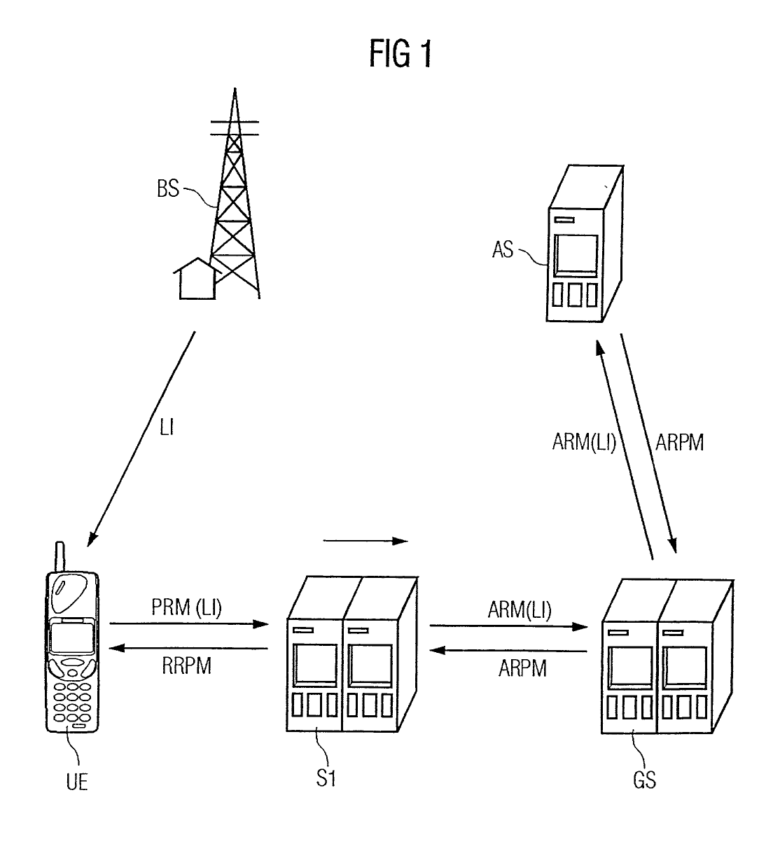

FIG. 1 shows a schematic overview of a communication system with first server (S1) and an authorization server (AS).

The communication system allows an advantageous implementation of the invention. However, the invention is not limited to the described communication system.

The number of servers is not limited. The communication system contains at least a first server (S1), which is capable of receiving a purchase request message (PRM) from a user equipment (UE) and an authorization server (AS).

However, it is possible to implement further servers as a gateway server (GS).

In the following, advantageous embodiments of the invention will be described more detail according to advanced on-line transaction services such as the Secure Electronic Transactions (SET™) Internet payment scheme.

However, the invention is not limited to the described examples. The invention implies a general solution for adding location information to a payment transaction. For better understanding, the mechanism is described in conjunction with the above mentioned SET™ payment protocol.

The communication network does not depend on a special transmission technology. Most preferably, the communication network allows the user equipment (UE) to be mobile. Though it is not necessary to implement a radio transmission path, usage of a suitable radio transmission path is advantageous. The radio transmission path can last from a few meters as, for example, according to the Bluetooth™ standard, a few kilometers in the case of cellular communication networks, up to thousands of kilometers, for example, in satellite-based communication networks. Cellular communication networks are preferably operated according to the Global System for Mobile Communication (GSM) or the Universal Mobile Telecommunication System (UMTS). However, mobility in this context also includes the user equipment (UE) being connected to other networks, for example through a socket.

Though the described example is preferred, each of the elements of the communication process described can be replaced by equivalent means.

A user equipment (UE) is capable of communicating in a multiple access communication system. Though it is not necessary that the multiple access communication system contain a radio link. An implementation of a radio link is advantageous to increase the mobility of the user equipment (UE).

The multiple access communication system preferably operates according to GSM, UMTS, or according to the Bluetooth™ standard.

The user equipment (UE) is capable of obtaining location information. In one implementation, the user equipment (UE) obtains an approximated location information by taking the location of the nearest base station (BS) as location of the user equipment (UE). The word base station (BS) does not imply any limitation as the invention can be carried out with different communication systems. Therefore the base station (BS) can also be a further mobile station, which functions at least partially as a base station (BS). For example in a communication system according to Bluetooth™ standard each of many user equipment (UE) can act as a base station (BS) for other user equipment (UE). An implementation of the position of the base station (BS) is especially useful in a Bluetooth™ environment, as the communication path in this system is very short, so that the position of the base station (BS) and the user equipment (UE) are similar within a range of a few meters.

To use a relative position of the user equipment (UE) to one or more base stations (BS) is especially advantageous in cellular multiple access systems with a high density of base stations (BS) as in GSM and UMTS communication systems.

However, it is also possible that the user equipment (UE) evaluates its system by making use of a positioning system. This is especially senseful if the user equipment (UE) has only a radio contact to one base station (BS) or if the base stations (BS) are far away from each other, such as, for example, in a satellite based communication system. However, an implementation of location coordinates is possible in any of the communication systems.

The multiple access communication system allows a connection between the user equipment (UE) and a first server (S1). The first server (S1) is a logical node, preferably operated by a merchant.

The first server (S1) is connected to a gateway server (GS).

The gateway server (GS) is connected to an authorization center (AC).

Though the invention is not limited to a payment system according to the SET standard, an implementation of the invention according to the SET standard is preferred.

It is advantageous to carry out the invention with a payment system according to the SET standard or another standard in which a purchase request message (PRM) sent from the user equipment (UE) to the first server (S1) includes an area for implementing additional information. Payment systems as SET with the possibility to implement additional information without limitations to formats allow implementation of various payment parameters.

The implementation of flexible data sets with the ability to add further payment conditioned parameters (PCP) at an ambiguous time is advantageous. For example, legalization in certain areas, regions, or states can change. These changes can be implemented in the payment system according to the invention.

If, for example, a city, a region, a state, or a country decides to forbid gambling, information about the prohibition can be implemented into the payment system.

This is a further advantage for credit card companies, as they can quickly adapt to changes in legislation and jurisdiction.

The communication between the first server (S1) and the gateway server (GS) preferably occurs, according to an appropriate protocol such as SET.

The gateway server (GS) is capable of communicating with an authorization server (AS).

By using the communication system and the payment system, payment transactions can be treated flexibly.

The invention can be implemented according to different operating routines. An operating routine can be adapted to the needs and desires of the users as well as those of money transferring entities such as credit card organizations. This allows location dependency to be handled different for different users or different types of users.

Credit card organizations often limit the amount that the users can spend in a certain time. In one embodiment of the invention, a spending limit is only checked if users are within their home country or outside. By analyzing the user is in his home country or not, the amount of accessible money can be triggered. For example, it is possible to reduce the amount of accessible money if people leave their home country or associated countries.

In a more complex implementation of the invention, the dependency on countries can be more precisely adapted to the needs of customers and credit card organizations.

For example, bearers of gold cards or frequent traveler cards can access large amounts of money even if they are outside their home zone but for some of the privileged users it may be useful to limit usage in certain high risk countries.

Therefore, the system can reduce transactions even of users holding gold or platinum cards if they are within certain high risk regions. In this way, usage of the card in high risk regions such as disadvantaged areas in less developed countries can be blocked.

This risk minimizing component can be flexibly combined with access to certain services.

To fulfil legal requirements in certain areas, the reason of the payment is evaluated. This reason is automatically treated and is, in an especially advantageous embodiment of the invention, combined with the location and/or movement of the user.

Preferably, the user equipment (UE) evaluates its location and/or movement. It is possible that the user equipment (UE) starts the evaluation of the location and/or movement automatically. However, it is also possible that the user equipment (UE) determines its position only if it is ordered to do so, for example, by the user or an external order, which could, for example, be obtained in a set up message.

The described sequences are part of a more complex signaling scenario. As various other elements of the communication system and of the payment system can be used, the invention is not limited to a specific implementation of them. To those skilled in the art it is known that they can adopt other parts of the communication flexibly, for example, by sending appropriate set up messages or appropriate communications on the bearers of the communication system.

The location information is preferably encrypted. For example, the purchase request message can contain encrypted location information.

Information about the location and/or the movement is added to a purchase request message, which is sent from the user equipment (UE) to the first server (S1).

It is especially advantageous that the location information and/or further parameters of conditions of the payment are encrypted with a key that cannot be decoded by the first server (S1). This inhibits manipulation by a fraudulent merchant in order to change the location information or the reasons of the payment.

Especially if location information is sent frequently, for example, to increase the position of the authorization, it is useful to encrypt the location information differently as the purchase request message (PRM).

If the location information is sent very often, a large number of messages exists and thus implies a risk that determinable information, especially the location itself, are evaluated and are compared with the encrypted message.

To prevent enablement of brute force attacks to derive the key used for encrypting the information, it is useful to encrypt the location information and other information contained in the purchase request message (PRM) with different keys.

An advantageous implementation for exchanging the key between the user equipment (UE) and the authorization server (AS) is described in FIG. 3.

FIG. 3 shows that the user equipment (UE) generates a digital envelope. The generation of the digital envelope involves usage of a secure key, for example, according to DES-standard or according to the triple-DES-standard. In FIG. 3, the generation of the key is marked by the reference number 1. The encryption of the location information is marked with the reference number 2.

Afterwards (reference number 3), a digital envelope (DE) is created and sent from the user equipment (UE) to the authorization server (AS).

The authorization server (AS) first decrypts (reference number 4) the key and afterwards encrypts the location information (reference number 5).

This allows, for example, prevention of paying for activities in one country and afterwards crossing to a country in which these activities are not allowed.

If, for example, a user starts a transaction in Mexico to pay for gambling, the system will not allow the transaction if it is invisible that he would enter the United States within a short time, especially the time in which the gambling takes place.

Afterwards it is described, how the preferred embodiments of the invention can be carried out according to the SET™ standard. In this embodiment, the user gives a subscription consent to the use location information for wireless credit card payment purposes. This consent can be considered part of the usual subscription procedure where the handling of other sensitive user information is defined (e.g., toll ticketing information or calling line ID settings). This consent could also be given at service invocation.

The implementation of the location information can occur according any method. However, it is especially preferably to implement the procedures described in the other parts of this application. If the network already provides location information, it is especially useful to use this information, as for example the Mobile Network Code (MNC) of GSM.

According to the SET™ standard, a payment starts by sending a purchase request message (PRM) from the user equipment (UE) to a first server (S1). SET provides the possibility to add further information to already specified messages by using so-called message extensions. This implementation proposes to use such an extension to carry the location information from the wallet application in the user equipment (UE) up to the issuer.

The first server (S1), which is preferably operated by or on behalf of a SET™ merchant, receives the purchase request message. The first server (S1) sends an authorization request message (ARM) to the SET Payment Gateway. The location information is carried to the Payment Gateway in a similar extension as described above.

Preferably the SET™ Payment Gateway itself also issues an authorization request to the SET issuer, which is typically the financial institution of the client.

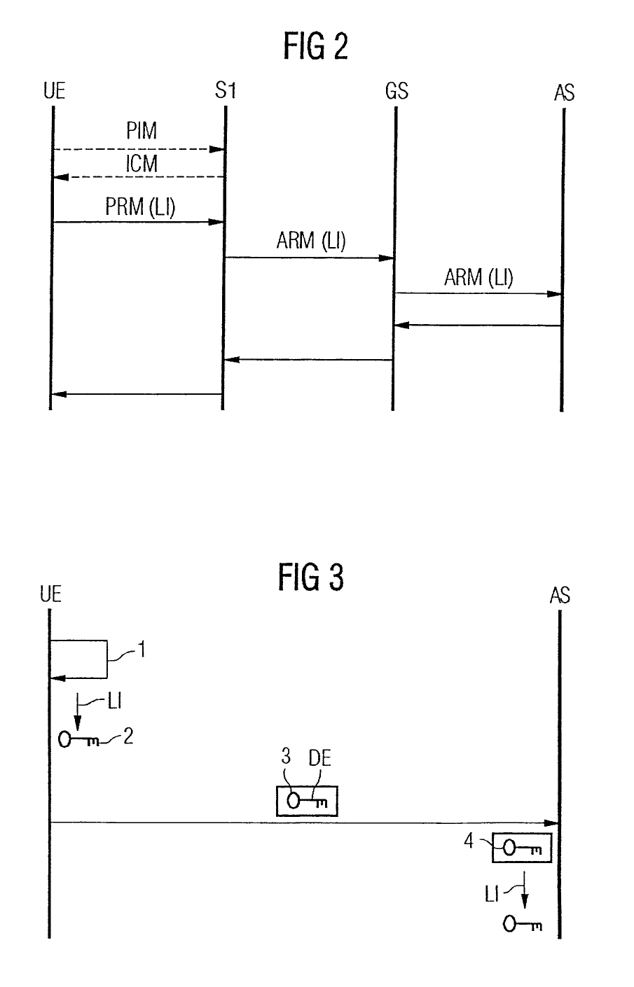

The authorization server (AS) processes on behalf of the SET™ issuer the authorization request message (ARM). For example, the authorization server (AS) could check the risk management specification for the current user and/or purchase transaction/location. If this specification puts any restrictions on the location information, this data is checked and corresponding action taken. The SET issuer may decide to decline the transaction based on the location information, or, as shown in FIG. 1 and FIG. 2, to accept it by returning an authorization response message (ARPM) to the SET Payment Gateway.

The SET Payment Gateway forwards the authorization response message (ARPM) to the first server (S1) in any suitable message format.

Optionally, the first server (S1) sends a payment response message (PRPM) to the user equipment (UE).

For those skilled in the art, it is evident that the measures, methods, and implementations described in this application can be combined with each other without limitation. Therefore, it is especially clear that the invention is neither limited to certain communication protocols nor to certain payment protocols.

Embodiments of the invention enable users to perform transactions in various regions and countries. A credit card issuing company which makes use of an embodiment of the invention gets the advantage that it can avoid risks of bad dept as well as risks of being held responsible for illegal actions of the users of their credit cards.

What is claimed is:

1. A method of automatically paying an amount to an account comprising:
acquiring an identifier and a transaction amount from user equipment;
verifying the transaction amount;
in response to the step of verifying, transferring the transaction amount from a customer account to the account;
wherein at least one parameter of the payment depends on the geographical position of the user equipment;
sending, by the user equipment, of a purchase request message to a first server, wherein the purchase request message includes information about the location of the user equipment;
sending, by the first server, of an authorization request message to an authorization server;
wherein the authorization request message includes location information;
evaluating, by the authorization server, of the location information;
sending, by the authorization server, of an authorization response message to the first server in response to the step of evaluating.

2. The method of claim 1, wherein the authorization request message comprises information about at least one payment condition parameter.

3. The method of claim 2, wherein the step of evaluating comprises evaluating the location information and at least one of the at least one payment condition parameter.

4. The method of claim 1, wherein the step of evaluating further comprises deciding about the authorization depending on a country in which the user equipment is located.

5. The method of claim 1, wherein the step of evaluating further comprises deciding about the authorization by evaluating a risk status of a region in which the user equipment is located.

6. The method of claim 2, wherein the at least one payment condition parameter comprises information about a payee.

7. The method of claim 2, wherein the at least one payment condition parameter comprises information about a payer.

8. The method of claim 2, wherein the at least one payment condition parameter comprises information about a reason of the payment.

9. The method of claim 1, wherein:
the location information is obtained from a position of a base station of a communication system; and
the base station is adapted to at least one of send and receive signals from the user equipment.

10. The method of claim 1, comprising evaluating a relative position between the user equipment and a base station of a multiple access communication system.

11. The method of claim 1, comprising evaluating a position of the user equipment relative to signal sending devices of a positioning system.

12. The method of claim 11, wherein the positioning system comprises a Global Positioning System.

13. The method of claim 1, wherein the purchase request message comprises encrypted location information.

14. A user equipment for communicating in a multiple access communication system, the user equipment comprising:
means for handling location information;
means for sending a purchase request message; and
means for adding location information to the purchase request message.

15. The user equipment of claim 14, wherein the user equipment is adapted to obtain the location information by taking the location of at least one base station.

16. The user equipment of claim 14, wherein the user equipment is adapted to obtain the location information by evaluating a position of the user equipment relative to at least one base station.

17. The user equipment of claim 14, wherein the user equipment is adapted to obtain coordinates relative to at least one signal sending device of a positioning system.

18. A server comprising:
means for receiving a purchase request message from a user equipment;
means for sending an authorization request message; and
wherein the purchase request message and the authorization request message comprise location information about the user equipment.

19. A payment system comprising:
a first server adapted to:
receive a purchase request message of a user equipment;
send an authorization request message; and
send an authorization request message to an authorization server by evaluating location information;
a gateway server;
an authorization server adapted to decide about an authorization of a payment; and
wherein the payment system is adapted to derive location information from the purchase request message.

20. An article of manufacture comprising:
at least one computer readable medium;
processor instructions contained on the at least one computer readable medium, the processor instructions configured to be readable from the at least one computer readable medium by at least one processor and thereby cause the at least one processor to operate as to:
control at least one of generation and sending of a purchase request message from the user equipment; and
add location information to the purchase request message.

21. The article of manufacture of claim 20, wherein the the processor instructions are further configured to be readable from the at least one computer readable medium by the at least one processor and thereby cause the at least one processor to operate as to encrypt the location information.

22. An article of manufacture comprising:
at least one computer readable medium;
processor instructions contained on the at least one computer readable medium, the processor instructions configured to be readable from the at least one computer readable medium by at least one processor and thereby cause the at least one processor to operate as to:
take location information from a purchase request message received by a first server; and
add the location information to an authorization request message sent from the first server to an authorization server.

23. An article of manufacture comprising:
at least one computer readable medium;
processor instructions contained on the at least one computer readable medium, the processor instructions configured to be readable from the at least one computer readable medium by at least one processor and thereby cause the at least one processor to operate as to:
decide about an authorization of a payment by evaluating location information included in an authorization request message.
